(19) United States
(12) Patent Application Publication
(10) Pub. No.: US 2004/0020055 A1
(43) Pub. Date: Feb. 5, 2004

(54) Pie cutter

(76) Inventor: Eyal Zuker, Van Nuys, CA (US)

Correspondence Address: ELLSWORTH R. ROSTON, HOWARD HUGHES CENTER, TENTH FLOOR, 6060 CENTER DRIVE, LOS ANGELES, CA, 90045, US

(21) Appl. No.: 10/210,310

(22) Filed: Aug. 1, 2002

(51) Int. Cl. A21C 5/08; A21C 15/04

(52) U.S. Cl. 30/114

(57) ABSTRACT

A pie cutter has a centrally disposed hinge and a plurality of cutting blades extending from the hinge. The blades are collapsible relative to one another so that the side walls of the blades are juxtaposed next to one another when the pie cutter is not in use. The blades may be expanded relative to one another to define a cylindrical configuration with the blades equally spaced angularly from one another to define cylindrical sectors. In a preferred embodiment, successive blades are joined at their outer peripheral ends by pivotable links which are collapsible when the pie cutter is not in use and which are expandable when the pie cutter is to be used. In another embodiment, a string extends in a loop through the outer peripheral ends of the blades and provides for a controlled movement of the blades between the collapsed and expanded relationships.

This invention relates to pie cutters and more particularly to pie cutters which have collapsed and expanded relationships and which cannot cut the pie into sectors in the collapsed relationship and which cuts the pie into sectors in the expanded relationship.

### BACKGROUND OF PREFERRED EMBODIMENTS OF THE INVENTION

After pies have been baked, they are cut into sectors to be eaten. Apparatus exists now for cutting a single sector from the pie. This apparatus comprises a pair of blades which are adjustable relative to each other to vary the size of the sector. However, apparatus does not exist which has a plurality of blades with collapsible and expandable dispositions relative to one another and in which the blades are movable from the collapsed relationship to the expanded relationship to provide for the cutting of the pie into a plurality of sectors.

### BRIEF DESCRIPTION OF PREFERRED EMBODIMENTS OF THE INVENTION

A pie cutter has a centrally disposed hinge and a plurality of cutting blades extending from the hinge. The blades are collapsible relative to one another so that the side walls of the blades are juxtaposed next to one another when the pie cutter is not in use. The blades may be expanded relative to one another to define a cylindrical configuration with the blades equally spaced angularly from one another to define cylindrical sectors.

In a preferred embodiment, successive blades are joined at their outer peripheral ends by pivotable links which are collapsible when the pie cutter is not in use and which are expandable when the pie cutter is to be used. In another embodiment, a string extends in a loop through the outer peripheral ends of the blades and provides for a controlled movement of the blades between the collapsed and expanded relationships.

### BRIEF DESCRIPTION OF THE DRAWINGS

In the drawings:

FIG. 1 is a perspective view of a collapsible pie cutter having a plurality of cutter blades and shows the blades of the pie cutter in a collapsed relationship;

FIG. 2 is a top plan view of the pie cutter and a pie and shows the blades in an expanded relationship to one another to provide a cutting of the pie by the blades into sectors of a cylinder;

FIG. 3 is an exploded side elevational view of the pie cutter when the pie cutter is disposed abo e the pie;

FIG. 4 is a fragmentary perspective view, similar to that shown in FIG. 1, of a collapsible pie cutter constituting a second embodiment of the invention and having a plurality of cutter blades and shows the pie cutter blades in an expanded relationship;

FIG. 5 is a side elevational view of a single blade of somewhat limited size in a pie cutter; and

FIG. 6 is a side elevational view of a single blade of an expanded size in a pie cutter.

### DETAILED DESCRIPTION OF PREFERRED EMBODIMENTS OF THE INVENTION

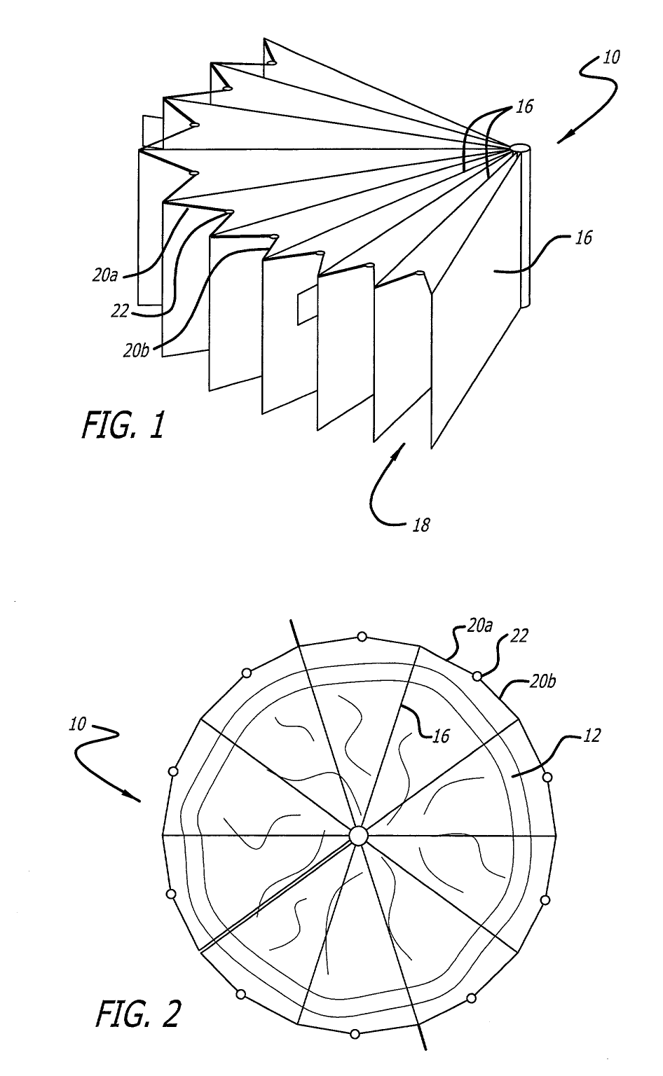

FIGS. 1-3 show a preferred embodiment, generally indicated at 10, of a pie cutter for cutting a pie 12 into segments. The pie 12 is shown as having a cylindrical configuration but it may have other configurations without departing from the scope of the invention. The pie 12 may be filled with different food items such as cheese, fruit, vegetables and/or meat.

The cutter 10 includes a plurality of blades 14. Each of the blades 14 may have the same dimensions as the other blades. Each of the blades has a fixed planar disposition. When the pie 12 is to be cut, each of the blades 14 may have a radial disposition so that each successive pair of blades defines a sector of a cylinder. Preferably the blades are spaced from each other, while the pie is being cut, so that the sectors defined by the successive pairs of blades have substantially identical dimensions. The blades 14 may be made from any suitable material such as a metal, a plastic or even a cardboard.

The blades 14 are attached at their inner ends to a hinge 16 so as to be rotatable at their inner ends. In one disposition the blades 14 have a collapsed relationship to one another as shown in FIG. 1. In this relationship, the blades 14 are positioned to define a configuration corresponding to a closed fan. In another disposition, the blades are displaced from one another to define an expanded relationship as shown in FIG. 2. In the expanded relationship, the blades 14 define sectors of a cylinder.

Linkage mechanisms generally indicated at 18 are connected at opposite ends to adjacent pairs of blades 14 at positions near the outer peripheries of the blades. Each of the linkages is formed from a pair of arms 20a and 20b which are attached to a pin 22. The arms 20a and 20b are pivotable on the pivot pin 22 (defining a fulcrum) to the collapsed relationship shown in FIG. 1 when the pie cutter 10 is not to be used. The arms 20a and 20b are pivotable on the fulcrum to the expanded relationship shown in FIG. 2 when the pie cutter is to be used to cut the pie 12 into sectors.

In the expanded relationship of the blades 14 in the pie cutter 10, the blades preferably extend beyond the outer periphery of the pie 10 so that the linkage mechanism 18 will not disturb, or impair the clean-cut image of, the pie while the pie is being cut. The linkages mechanism 18 also help to maintain the pie cutter in the expanded relationship shown in FIG. 2 while the pie is being cut. The blades 14 are dimensioned to extend through the full thickness of the pie 12 when the cutter 10 has the expanded relationship shown in FIG. 2.

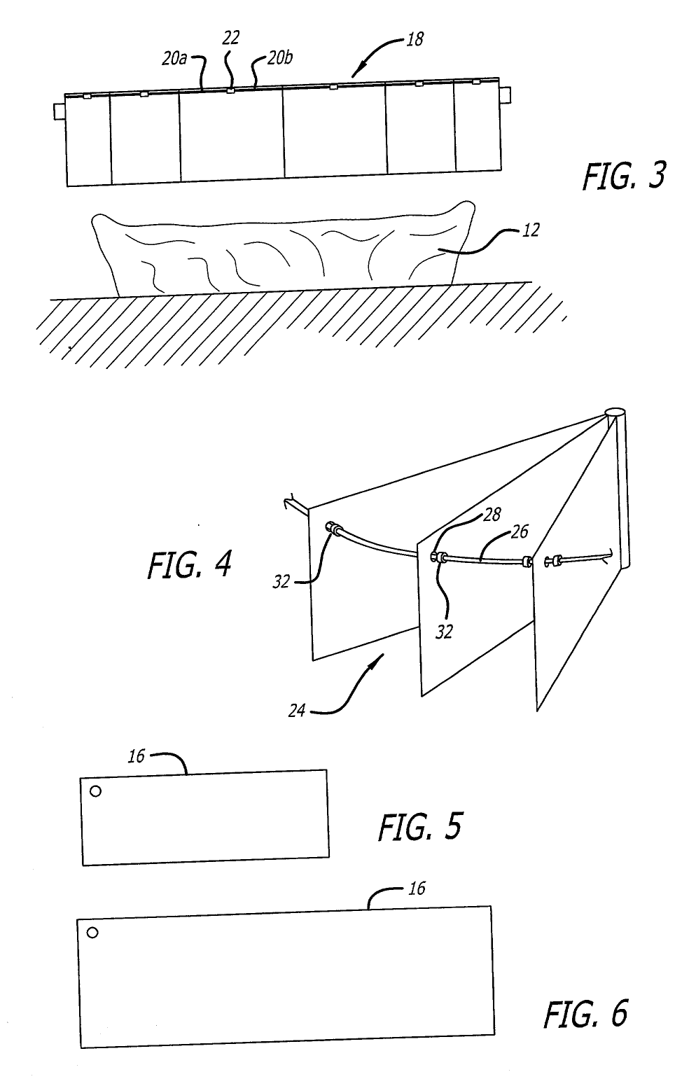

FIG. 4 shows another embodiment, generally indicated at 24, of the cutter. In this cutter, the linkage mechanism constitutes a string 26 which extends through holes 28 in blades 30 near the outer peripheries of the blades. Stops 32 are disposed on the string 26 on the opposite sides of each of the holes 28 to confine the portion of the string between adjacent pairs of blades between the adjacent pairs of blades whether the cutter 24 is in the collapsed relationship or the expanded relationship. The use of the string 26 and the stops 32 has certain advantages. One advantage is that the string 26 is relatively simple in construction and usage. Another advantage is that the string 26 can be crumpled into any desired shape in the collapsed configuration of the cutter 24 and can be easily expanded to a taut relationship in its distance to provide for the disposition of the blades 30 in the expanded relationship. The portion of the string between each adjacent pair of blades 14 can be considered as a linkage.

FIGS. 5 and 6 show how blades of different heights and lengths can be used to form the pie cutter. The use of blades of different heights and lengths will of course depend upon the size of the pie.

Although this invention has been disclosed and illustrated with reference to particular embodiments, the principles involved are susceptible for use in numerous other embodiments which will be apparent to persons of ordinary skill in the art. The invention is, therefore, to be limited only as indicated by the scope of the claims.

What is claimed is:

1. A pie cutter, including
a plurality of blades each constructed to cut the pie,
a hinge for supporting the blades near the inner peripheral ends of the blades in a pivotable relationship to one another, and
a plurality of linkages each extending between an adjacent pair of the blades near the outer peripheral ends of the blades and each being movable between collapsed and expandable relationships to define a folded fan-like disposition of the blades in the collapsed relationship and to define blades spaced from one another in the expanded relationship and defining sectors of the pie.

2. A pie cutter as set forth in claim 1 wherein each of the linkages disposed between a successive pair of the blades is collapsible and expandable and is disposed in the collapsed relationship when the pie cutter is not in use and is provided in the expanded relationship when the pie cutter is to be used to cut the pie.

3. A pie cutter as set forth in claim 2 wherein each linkage is provided with a pair of arms pivotable relative to each other on a fulcrum at a position between the blades in the pair and wherein the arms are pivotable toward each other to define the collapsed relationship of the linkages and are pivotable away from each other to define the expanded relationship of the linkage.

4. A pie cutter as set forth in claim 3 wherein
a pivot pin is provided at the fulcrum of the arms in each linkage to provide for the pivoting of the arms in the linkage toward or away from each other.

5. A pie cutter as set forth in claim 1 wherein
the blades are disposed relative to one another in the expanded relationship of the linkages to cut the pie into sectors.

6. A pie cutter as set forth in claim 5 wherein
the sectors cut by the blades are of substantially equal volume.

7. A pie cutter as set forth in claim 5 wherein
the linkage mechanism constitutes a string extending through the blades near the outer peripheries of the blades and having collapsed and expanded relationships.

8. A pie cutter as set forth in claim 7 wherein
the string extends through holes in the blades near the outer peripheral ends of the blades and wherein stops are provided on the string near the holes to maintain portions of the string within the space between adjacent pairs of blades.

9. A pie cutter, including,
a plurality of blades each constructed to cut the pie,
a hinge near the inner peripheries of the blades for maintaining the blades in a first co-operative relationship defining a collapsed disposition relative to one another and in a second cooperative relationship defining an expanded disposition relative to one another,
a linkage mechanism provided near the outer peripheries of the blades and provided with a first relationship to maintain the blades in the collapsed disposition relative to one another and provided with a second relationship to maintain the blades in the expanded disposition relative to one another,
the blades being disposed in the expanded disposition to cut the blades into sectors.

10. A pie cutter as set forth in claim 9 wherein
the linkage mechanism is a string extending through the blades near the outer periphery of the blades and having a relaxed disposition in the first relationship and having a tightened disposition in the second relationship.

11. A pie cutter as set forth in claim 10 wherein
the string extends through holes in the blades near the outer peripheral ends of the blades and wherein stops are disposed on the string at positions near the holes in the blades to confine the movements of each portion of the string to the sector in which the portion of the sting is located, the sector being defined by a pair of adjacent blades.

12. A pie cutter as set forth in claim 9 wherein
the linkage mechanism is formed from a plurality of linkages each disposed between an individual one of an adjacent pair of blades and each having a collapsed disposition providing for a collapse of the spacing between the blades in the pair and having an expanded disposition providing for the spacing of the blades in the pair.

13. A pie cutter as set forth in claim 12 wherein
each of the linkages includes a pair of arms pivotable relative to each other between the collapsed and expanded dispositions.

14. A pie cutter as set forth in claim 13 wherein
the pair of arms in each linkage are pivotable relative to each other on a fulcrum defined by a pivot pin common to the arms in the linkage.

15. A pie cutter as set forth in claim 9 wherein
the linkage mechanism is disposed beyond the outer periphery of the pie to maintain the visual appearance of the pie when the pie is cut by the blades.

16. A pie cutter as set forth in claim 9 wherein
the blades are disposed relative to each other in the extended relationship to form sectors of substantially equal area.

17. A pie cutter, including,
a plurality of blades each having a fixed planar disposition and each constructed to extend through the pie,
a support holding the inner ends of the blades in a relationship to provide for a collapsed disposition of the blades relative to one another in a first relationship and for a spaced disposition of the blades relative to one another in a second relationship, and
a linkage mechanism disposed between adjacent pairs of the blades near the outer ends of the blades and having first and second dispositions and operative in the first disposition to provide for a retention of the outer ends of the blades in a contiguous relationship and operative in the second disposition to provide for a retention of the outer ends of the blades in each pair in a spaced relationship.

18. A pie cutter as set forth in claim 17 wherein
the blades extend from the center of the pie to a position beyond the outer periphery of the pie and wherein the linkage mechanism is disposed beyond the outer periphery of the pie.

19. A pie cutter as set forth in claim 17 wherein
the blades have holes near their outer peripheries and wherein a member alternately having relaxed and taut dispositions extends in a closed loop through the holes in the blades and have the relaxed disposition with the disposition of the outer ends of the blades in the contiguous relationship and have the taut disposition with the disposition of the outer ends of the blades in the spaced relationship.

20. A pie cutter as set forth in claim 19 wherein
stops are disposed on the string adjacent the holes in the blades to limit the movement of the stops on the string adjacent the holes in the blades to limit the movement of the portions of the string between adjacent pairs of blades.

21. A pie cutter as set forth in claim 17 wherein
the linkage mechanism includes a plurality of linkages each disposed between an individual pair of the adjacent blades and each having a first operative relationship to hold the outer ends of the blades in the contiguous relationship and each having a second operative relationship to hold the outer ends of the blades in the spaced relationship.

22. A pie cutter as set forth in claim 21 wherein
each of the linkages has first and second arms respectively coupled to the individual one of the blades in the pair and wherein
the arms in each of the linkages are pivotable relative to each other at an intermediate position between the blades to which the arms are coupled.

23. A pie cutter as set forth in claim 22 wherein
a pin is disposed in each of the linkages on the ends of the arms displaced from the blades and wherein the pin provides a fulcrum for the pivotable movement of the arms relative to each other between collapsed and expanded relationships.

24. A pie cutter as set forth in claim 18 wherein
the blades have holes near their outer peripheries and wherein a member alternately having relaxed and taut dispositions extends in a closed loop through the holes in the blades and have the relaxed disposition with the disposition of the outer ends of the blades in the contiguous relationship and have the taut disposition with the disposition of the outer ends of the blades in the spaced relationship and wherein
stops are disposed on the string adjacent the holes in the blades to limit the movement of the portions of the string between adjacent pairs of blades.

25. A pie cutter as set forth in claim 18 wherein
the linkage mechanism includes a plurality of linkages each disposed between an individual pair of the adjacent blades and each having a first operative relationship to hold the outer ends of the blades in the contiguous relationship and each having a second operative relationship to hold the outer ends of the blades in the spaced relationship and wherein
each of the linkages has first and second arms respectively coupled to the individual one of the blades in the pair and wherein
the arms in each of the linkages are pivotable relative to each other at an intermediate position between the blades to which the arms are coupled.
